(19) United States
(12) Patent Application Publication
(10) Pub. No.: US 2010/0039818 A1
(43) Pub. Date: Feb. 18, 2010

(54) NUMISMATIC STORAGE CONTAINER TO PREVENT COUNTERFEITING OF COINAGE

(75) Inventor: Richard M. Haddock, Redwood City, CA (US)

Correspondence Address: SCHNECK & SCHNECK, P.O. BOX 2-E, SAN JOSE, CA, 95109-0005, US

(73) Assignee: COINSECURE, INC., Mountain View, CA (US)

(21) Appl. No.: 12/543,325

(22) Filed: Aug. 18, 2009

Related U.S. Application Data
(60) Provisional application No. 61/089,591, filed on Aug. 18, 2008.

(51) Int. Cl. F21V 33/00; B65D 85/02

(52) U.S. Cl. 362/253; 206/81

(57) ABSTRACT

In various exemplary embodiments, a coin storage device is disclosed. The coin storage device comprises an encapsulation portion configured to secure a coin therein and allow for visual inspection of the coin. A viewing port is arranged on an edge of the encapsulation portion and is configured to both allow a light source to impinge upon an edge of the coin and return a light signal from the edge of the coin.

### CROSS-REFERENCE TO RELATED APPLICATION

This application claims priority under 35 U.S.C. 119(e) from prior U.S. provisional application No. 61/089,591, filed Aug. 18, 2008.

### TECHNICAL FIELD

The present invention relates generally to coin collecting and valuation of coins, and more particularly, to a numismatic storage container allowing coin edge scattering verification thereby preventing counterfeiting of coins.

### BACKGROUND

The interest in the collection and conservation of coins and related objects has been historically considered a personal interest activity, with little formal standards or controls concerning the trading of coins. The recent rise in the value of coins compared to earlier levels has promoted trading of coins to a higher degree of professional structure, most significantly by the advent of commercial third party coin grading services who have developed systems to apply a widely accepted quality grade (based on a numerical scale from 1 to 70 with 70 being the highest quality). After examining and determining the grade of a coin, the commercial services place the coin in a clear plastic holder in which a grade label with a reference barcode is affixed. The clear plastic holder is then ultrasonically welded around the coin, thus permanently linking the grade to the coin within the case. A barcode is linked to the database which can be searched to confirm that the referenced coin was graded by the commercial service, along with some additional transaction details such as the date, place, person grading the coin, etc.

The grading service charges a fee for the provided services and gives a warranty of grading accuracy as part of the transaction value. The result of this commercial service is to allow the plastic encapsulated coins to be more readily traded as their trade value is directly linked to the professional quality grade on the plastic holder.

However, the current commercial grading services lack repeatability and consistency. Further, contemporary services are unable to prevent “grader-shopping” in which a coin owner may specifically hunt for the highest value for a given coin since there is currently not a common database or rigorous objective means for identifying a specific coin.

Perhaps more importantly, there is currently no simple and robust means to prevent coin counterfeiting. Therefore, what is needed is a way to uniquely and quickly identify a particular coin that avoids counterfeiting.

### SUMMARY

In various exemplary embodiments, a coin storage device is disclosed. The coin storage device comprises an encapsulation portion configured to secure a coin therein and allow for visual inspection of the coin. A viewing port is arranged on an edge of the encapsulation portion and is configured to both allow a light source to impinge upon an edge of the coin and return a light signal from the edge of the coin.

### BRIEF DESCRIPTION OF THE DRAWINGS

Various ones of the appended drawings merely illustrate exemplary embodiments of the present invention and must not be considered as limiting its scope.

FIG. 1 is an exemplary embodiment of an apparatus to store a coin while allowing scanning of at least a portion of the edge of the coin.

FIG. 2A is a simplified isometric drawing of an exemplary embodiment of an apparatus to concurrently provide three views on and near the edge of a coin.

FIG. 2B is a top view of the apparatus of FIG. 2A.

FIG. 2C is a cross-sectional view of the apparatus of FIG. 2A at a position as indicated in FIG. 2B.

FIG. 2D is an elevational view of the apparatus of FIG. 2A.

FIG. 3 is an exemplary embodiment of an apparatus to provide scattering signatures of coins in accordance with various aspects of the present invention.

FIG. 4 is a side view of an optical coin scanner and a stage, the stage configured to hold a coin storage container.

FIG. 5 is a top view of a stage configured to hold a coin storage container.

### DETAILED DESCRIPTION

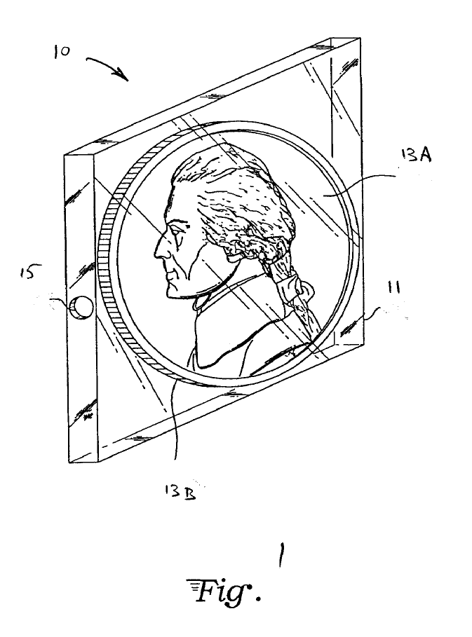

Referring now to FIG. 1, an exemplary coin encapsulation system 10 includes a coin slab 301 with a viewing port 15. A coin 13A having an edge 13B is mounted inside of the coin slab 11.

The coin slab 11 may be fabricated from a variety of transparent materials such as poly(methyl methacrylate) (PMMA) or poly(methyl 2-methylpropenoate) that are commonly sold under trade names such as Plexiglass® or Lucite®. Other materials such as polycarbonate or other hard, transparent plastics may be used successfully as well. Various types of soda-lime glass, borosilicate glass, and similar materials may also be used. Ideally, the only restrictions are that any material used to fabricate the coin slab 11 should be transparent, to visually inspect the coin 13A contained therein, and have little or no outgassing, to avoid damaging the coin 13A. Outgassing can cause surface damage to fine coins (e.g., depositing a thin layer of polyvinyl chloride) which may severely limit a valuation of any coin.

Depending upon the material chosen to fabricate the coin slab 11, the coin 13A may be encapsulated by ultrasonically welding edges of the coin slab 11 such as when a hard plastic is chosen. For all material types, an adhesive material may be used to bond edges of the coin slab 11, one to another. Coin slabs used for simple visual inspection of a coin are known independently in the art. However, none of the prior art coin slabs are able to accommodate re-certification or re-grading of a coin through analyses of a light source incident on any part of the coin. Certainly, none of the prior art coin slabs currently available allow any type of re-grading without destructively opening the coin slab to first remove the coin prior to re-grading.

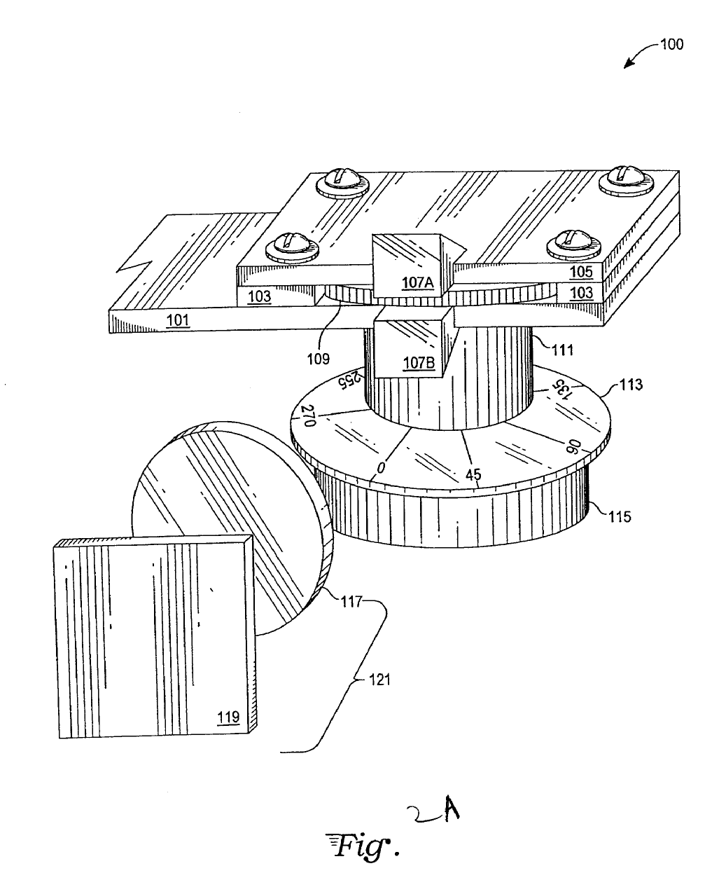

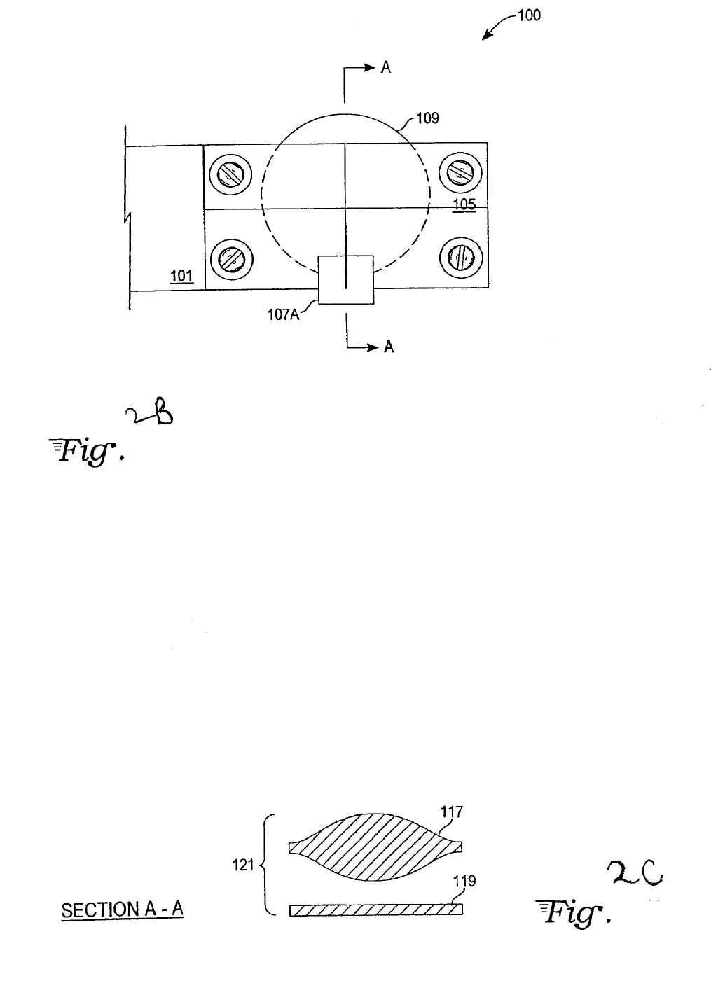

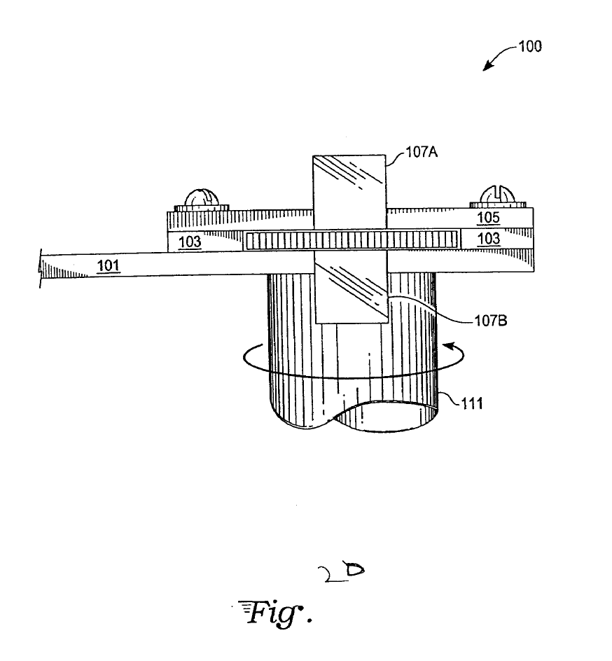

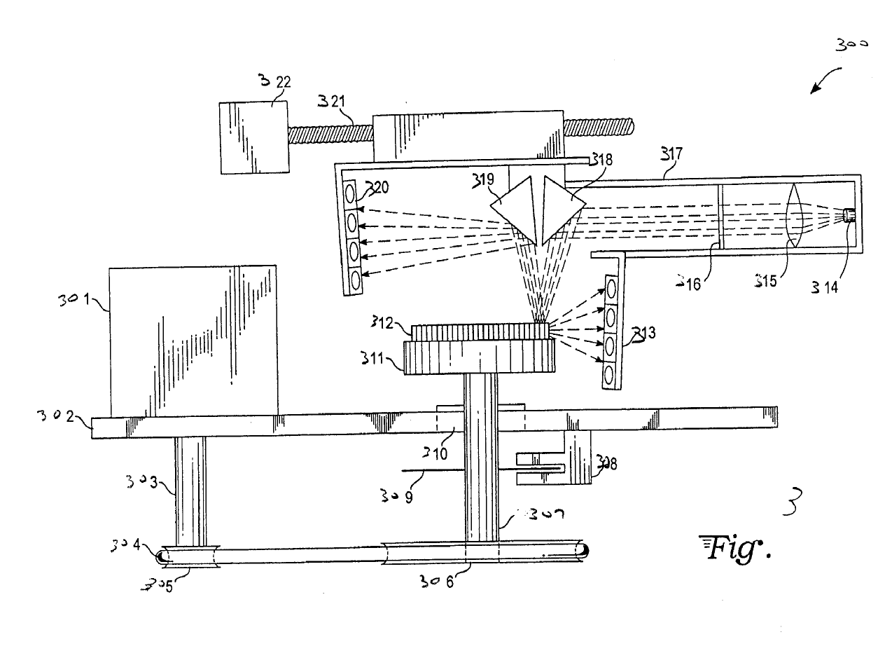

In one exemplary embodiment, the viewing port 15 may simply be an open air port allowing unimpeded access of a light, such as the light source 314 (FIG. 3) described above or used with the imaging system 121 of FIG. 2A. The viewing port may be virtually any size or shape. In a specific exemplary embodiment, the viewing port 15 is approximately two millimeters in diameter. In another specific exemplary embodiment, the viewing port 15 is approximately one millimeter in diameter.

In another embodiment (not shown directly but understandable to one of skill in the art), the viewing port 15 may be a fiber optic tube or imaging rod with one end placed in proximity to the edge 13B of the coin 13A. In still another embodiment (not shown directly but understandable to one of skill in the art), the viewing port 15 may be another type of optical element such as, for example, a gradient-index (GRIN) lens. In any of these or similar types of cases, the viewing port 15 provides a means to both couple a light source to the edge 13B of the coin 13A and receive scattered, reflected, or diffracted light back to a detector element or other imaging system without having to remove the coin 13A from the coin slab 11. Any such optical element incorporated into a coin holder and useful for the collection of light from or illumination of a coin edge, coin surface, or transition region (e.g., edge to face, edge to back transition) will be referred to as an “edge coupling optic.”

The value of the coin grading process includes an ability to uniquely identify a specific coin by the detection and extraction of discernible coin specific features. The coin specific features are noted by concurrently recording a 360° panoramic view of both near-edge obverse and reverse features as well as the edge of the coin. The coin storage device in FIG. 1 allows the edge of an encapsulated coin to be viewed in a manner that facilitates identification of a coin that has been previously graded without having to remove the coin from its slab.

The creation of such a system solves many problems in the existing coin grading and certification business and adds value to the coin for the benefit of the coin owner. One benefit includes an ability of a party to identify the encapsulated coin to review the last grade and certification reports. Even though a slab containing a graded coin initially includes an adhered identifying label, such identification can become worn or lost over time. Inasmuch as a coin's numismatic value may be reduced by even slight scratches and dings, avoiding any unnecessary removal of a coin from its protective slab while still permitting proper identification of the encapsulated coin would be of benefit in such cases.

Further, a unique coin identification can reduce insurance costs by providing more absolute proof of ownership in the case of theft or loss. The original identifying label could be removed by a thief and replaced with a phony label, so the ability to confirm a coin's identity independently of its label would be an advantage. A permanent record of the coin ownership history can be created adding a pedigree value to the coin.

Due to the coin stamping process, each coin is unique, even when the coin stamping process occurs at the same mint and on the same coin-type. A single coin-type requires three stamping dies, one die each for the obverse and reverse faces of the coin and one for the edge of the coin. However, each coin has a unique stamping signature due to even slight misalignment issues between the three dies and imposed “jitter” (i.e., an unintentional variation in the stamping process caused by factors such as slight vibrational effects) while the stamping process is performed.

An apparatus is provided that records unique permanent features of a coin as an electronic identification file, thus allowing subsequent searchers to find and verify a specific coin. The system comprises several components functioning together to provide an ability to analyze, capture, record, store, and retrieve any one or more of a variety of physical coin characteristics that, taken together, can uniquely identify a given coin against a population of a million or more nearly identical versions of the same coin. A partial list of physical characteristics includes:
1) Surface damage of small nicks, scratches, and dings on all three coin surfaces (obverse or front side, reverse or back side, and coin edges);
2) Coin image relief height and placements;
3) Coin thickness and eccentricity;
4) Coin surface reflectivity of all surfaces;
5) Coin color and spectral response of all surfaces;
6) Alignment and registration variations of the three surfaces in relationship to each other;
7) Variations in alloys by coin;
8) Weight of the coin; and
9) Density variations within the coin.

Several of these features can be observed from an edge of a coin. These characteristics can be taken singularly or in combination to develop an algorithm to represent a specific coin, or portion of the coin, as a mathematical expression stored as a digital file, discussed in detail, below. A resulting “coinprint” file is designed to allow a rapid search across a database containing a multitude of similar files to allow finding and retrieving the original file record for any subsequent presentation of the same coin to the system. The search and retrieval efficiency should be such that the look up search function can be performed in under 10 seconds when searching for 1 coin against a population of 1 million similar coins previously recorded within the database. The entire process of scanning a coin can be completed in under 30 seconds.

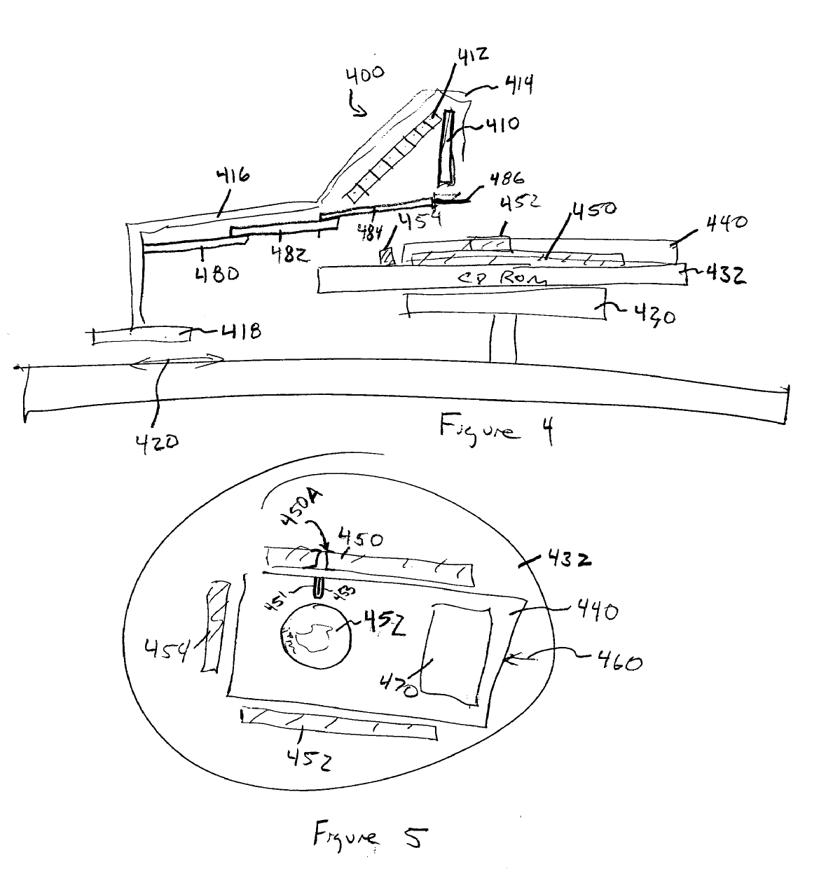

The device shown in FIG. 4 provides one illustration of a coin in a coin holder configured to be scanned. A coin scan head 400 includes a sled mounted on arm 416. Arm 416 is mounted in a movable platform 418. This allows the sled to be moved along an axis as indicated by arrows 420. In the interior of scan head 400 is an illumination source (e.g., a laser) 410. Scattered light may be detected by detectors 412. A segmented detector allows a measurement of light scatter intensity along the length of the detector. The illustrated detector has eight segments, allowing scattering to be detected at any integration interval from eight areas of scattering detection.

Mounted on turntable 430 is a CD ROM mount 432. On mount 432 is placed a coin box 440 holding coin 452 secured by side guide wall 450 and rear guide wall 454. The scattering may be detected in one of two manners. First, the light produced by illumination source 410 may pass through the transparent material of the coin box 440 and illuminate an obverse or reverse surface of the coin. Light scattered by coin 452 would be detected by detectors 412. The transparent material of coin box 440 would also scatter, reflect or redirect some light. However, this should be repeatable, allowing a unique signature to still be gathered from a scan of a coin held in a coin box. In addition, a photo of the coin could also be captured by detector elements. Turntable 430 would be rotated at a selected speed. The detectors would then integrate the detected signals at a selected interval. This would allow scattering to be detected from specific arcs around a circumferential track. In one alternative, the laser could be targeted onto the upward-facing surface near the edge of the coin.

Alternatively, a scanner could be used that redirects light from the illumination source 410. Telescoping lengths 480, 482, 484 can be used to hold light redirecting optic 486. This optic (e.g., a fiber optic element, redirecting mirror or other element) could then redirect the illumination light to the side of the coin. As shown in FIG. 1, a viewing port may be used either with our without an edge coupling optic. This would allow detection without illuminating through the material that makes up the coin box 440. A second mirror or other optical component may be required to direct the illumination light to the viewing port and from the viewing port onto the detectors. Because the illumination light and the scattering light are of the same wavelength, the illumination light and the scattered light preferably are not collected from a coincident pathway. Polarization separation of the scattered light from polarized illumination light might also be employed. Preferably for ease of comparison of coin signatures, the coin would be scanned after encapsulation in a coin box. This signature could be stored (e.g., in a database) for identification by comparison with a later scan of the same coin box encapsulated coin.

With respect to FIG. 5, the top view shown shows the coin 452 held in a coin box 440 on mount 432. The coin box 440 includes a label 470 which may be on the interior or exterior of the box and is preferably affixed to the box. In addition the coin 452 is held within the box. The position of the coin box 440 is indexed into a fixed, repeatable position by side guide walls 450 and 452 and rear guide wall 454. The user would simply push the coin box in the direction of arrow 460, and the coin box 440 would be in a known position. This use of coins encapsulated into a standard sized box would have the advantage of eliminating the need for centering mechanisms or use of adapters. This in turn makes scanning coins a bit quicker. In addition, the fact that the coins are at a known location within the box could also make finding the coin location to begin a scan more rapid.

The edge coupling optic 451 and 453 is shown as a pair of optical fibers. One is used to transmit the illumination light and the other is used to transmit collected scattered light. An additional lens may be used to collect scattered light from a greater area. The side guide wall 450 may be sufficiently short that it does not block edge coupling optic 451, 453. Alternatively, a passage 450a may be included to allow transmission of an optical fiber or other illumination light and scattered light to pass on to detection elements.

Once the coin is scanned and the coinprint file developed, a numismatic storage apparatus allows coin storage. At least a portion of an edge of the coin can be scanned without removing the coin from the storage apparatus. Alternatively, the coin may be placed into the storage apparatus prior to scanning and the edge portion alone may be used for coin identification.

With reference now to FIG. 2A, a coin imaging apparatus 100 includes a support plate 101, a plurality of spacers 103, and a top plate 105. The support plate 101, plurality of spacers 103, and top plate 105 may be formed from a variety of materials including various metals and plastics. The support plate 101 may be fastened on one edge and cantilevered as shown. Alternatively, the support plate 101 may be fastened on two ends or in another way to provide support for the plurality of spacers 103 and top plate 105.

A first 107A and a second 107B prism are mounted to the top plate 105 and the support plate 101 respectively. The first prism 107A directs an image of the near-edge obverse surface of a coin 109 towards an imaging lens 117. The second prism 107B directs an image of the near-edge reverse surface of the coin 109 towards the imaging lens 117.

The coin 109 is placed or otherwise mounted atop a rotating pedestal 111. Means for centering the coin 109 upon the rotating pedestal 111 are known in the art. An optional reference disk 113 may be employed to provide a rough indication of angular rotation of the coin 109 to a user. The rotating pedestal 111 is controlled by and coupled to a rotary encoder system 115.

The rotary encoder system 115 may be a servo or a stepper motor with, for example, an optical encoder, to provide an electronic output of a precise angular position of the coin 109. Motors and related systems for providing angular output information are known in the art.

The imaging lens 117 directs the image to a recording device 119. The recording device may be any type of sensor known in the art to record images such as a CCD array or CMOS sensor. A combination of the imaging lens 117 and the recording device 119 is representative of an imaging system 121 such as a digital still or video camera (neither of which is shown explicitly).

Images from the imaging system 121 may be linked with the electronic output of the precise angular position of the coin 109, thus forming a composite record. The composite record will uniquely identify any coin thereby preventing possible coin counterfeiting as each coin edge is different as noted above.

The first 107A and second 107B prisms are arranged in relation to the edge of the coin 109 such that the imaging lens 117 concurrently views three images of the coin 109. A first image is viewed directly of the edge of the coin 109. The first 107A and second 107B prisms are arranged such that near-edge features on both the obverse and reverse sides of the coin 109 are imaged simultaneously with the edge view.

With reference to FIG. 2B, a top view of the coin imaging apparatus 100 indicates an overall relationship of the various components employed. (The optional reference disk 113 and the rotary encoder system 115 are not shown to preserve clarity.) A cross-sectional view A-A of FIG. 2B, as indicated by referring to FIG. 2C, provides additional detail of the first 107A and second 107B prisms in relation to the edge of the coin 109.

As will be recognizable to a skilled artisan, the area viewable by the imaging lens 117 of the obverse and reverse portions of the coin 109 is determined by the size and placement of the first 107A and second 107B prisms. Larger prisms may be placed so as to image larger portions of the coin 109. Additionally, the first 107A and second 107B prisms may be placed in relationship to the coin edge such that the reflected obverse and reverse sides of the coin 109 are substantially the same distance from the imaging lens 117 as is the distance from the edge of the coin 109 to the imaging lens 117, thereby mitigating any deleterious depth-of-focus problems. In another exemplary embodiment, the first 107A and second 107B prisms are replaced by front surface mirrors (not shown).

Referring now to FIG. 2D, a front elevational view of the coin imaging apparatus 100 indicates that a thickness of the plurality of spacers 103 is determined based upon the thickest coin that is anticipated to be used in the coin imaging apparatus 100. The thickness of the plurality of spacers is thicker than the thickest coin used in the coin imaging apparatus 100.

With reference now to FIG. 3, an exemplary embodiment of a scattering apparatus 300 for coins includes two main sections comprising a mechanical coin drive sub-system and an optical sub-system.

The mechanical coin drive sub-system includes a motor 301 for a rotary, a base plate 302, a stepper output shaft 303, an o-ring drive belt 304, a motor pulley 305, an output pulley 306, and a platform shaft 307. An optical encoder sensor 308 reads rotational positional information from an optical position encoder 309 mounted concentrically with the platform shaft 307.

A person of skill in the art will recognize the optical position encoder 309 could be mounted in other locations such as, for example, concentrically with the stepper output shaft 303 provided any slippage between the motor pulley 305 and the output pulley 306 is accounted for properly (e.g., the o-ring drive belt 304 may be replaced by a gear train thus eliminating potential belt variability or slippage). Alternatively, the motor 301 could be a stepper motor with incremental encoding or a servo motor with a rotary encoder thus potentially eliminating any need for a separate combination of optical encoder sensor 308/optical position encoder 309.

With continued reference to FIG. 3, a precision bearing 310 allows alignment of the platform shaft 307 as it passes through the base plate 302. A sample platform 311 allows placement of a sample coin 312 for optical inspection and characterization. The sample platform 311 is chosen based upon the largest coin size expected. In a specific exemplary embodiment, the sample platform 311 may be approximately 50 mm or less in diameter. The sample platform 311 may contain or be used in conjunction with a self-centering loading and indexing coin handling sub-system (not shown).

The optical sub-system includes an output PiN diode array 313 arranged to capture light scattered in the far-field from either the surface or near-surface of the sample coin 312, depending upon the type of coin being characterized. This characterization feature is described in more detail, below. The output PiN diode array 313 may be arranged to collect scattered light in, for example, a vertical or horizontal orientation. Alternatively, some other solid angle of light may be collected such as a full hemisphere of scattered light.

The output PiN diode array 313 may contain a variable sized array of only a few or several hundred photodiodes. A particular array size may be selected depending upon a level of resolution required to collect scattering signatures. The output PiN diode array 313 may also be any type of optical detector capable of converting light input into a voltage or current output. A skilled artisan will recognize that other types of light-detecting sensors may be employed either in conjunction with or as a substitute for the output PiN diode array 313. Other types of light-detecting sensors include PN photodiodes, CMOS sensor arrays, or CCD sensor arrays. Additionally, a variety of other types of either multi-segmented or arrayed sensors known in the art may readily be adapted for use in the scattering apparatus 300. Moreover, tri-color imaging sensors may be used to evaluate color and compositional elements of the sample coin 312.

The output PiN diode array 313 may also include an analyzer (not shown) placed between the sample coin 312 and the output PiN diode array 313. The analyzer allows for particular polarization states (e.g., in the form of recorded Stokes parameters) to be considered for the sample coin 312.

Depending upon the type of optical collection device chosen, collected data may be read out either serially or in parallel to be stored, displayed, or compared with other scattering signatures by, for example, a microprocessor (not shown). The microprocessor may be arranged as a part of the scattering apparatus 300 or in a stand-alone computer. Methods and techniques for storing, displaying, and comparing the data are known in the art. For example, the data may be displayed and stored as a bi-directional reflectance distribution function (BRDF) at various locations on the sample coin 312. The BRDF is defined in radiometric terms as surface irradiance divided by incident surface irradiance. The BRDF thus becomes:

$$B R D F = \frac{differential radiance}{differential irradiance} ≅ \frac{\frac{\partial {P}_{s}}{\partial {Ω}_{s}}}{{P}_{i} cos ( {θ}_{s} )}$$

where Pₛ is light flux scattered through a solid angle, Ωₛ, Pᵢ is incident power at a projected solid angle θₛ (cos (θₛ) is merely a correction factor to adjust an illuminated area to an apparent size in the scattered direction).

Alternatively (or in addition to the BRDF), an auto-covariance function or a spatial power spectral density function (PSD) may be calculated from the BRDF data and used as powerful statistical tools for comparing and isolating the scattering signature from one coin from another. Also, skilled artisans are familiar with other types of scattering distribution analyses and comparisons. For example, a simple histogram plotting scattering intensity (e.g., absolute intensity or normalized by irradiance) for each sensor may be displayed and stored. In still other alternatives, a scattering plot displaying intensity as a function of sensor in an x-y or polar coordinate mapping may be used as well.

Regardless of how scattering statistics are stored, displayed, or compared, a registration mark (not shown) may be etched or otherwise marked onto the sample platform 311 to provide a starting point for displaying and comparing various scattering signatures or plots. The registration mark may simply be a small etched line or other geometric feature to produce a known scattering signature as a readily identifiable scattering feature. For example, a small (e.g., 100 μm by 100 μm) area may be etched with a square wave pattern on an outer periphery the sample platform 311 (i.e., so as not to be obscured or covered by the sample coin 312). The square wave pattern would have a highly recognizable scattering signature (e.g., a 50% duty-cycle square wave produces an odd-order Fourier scattering pattern identifiable as distinct peaks in a BRDF or PSD plot). Optionally, either any given point on the sample coin 312 (e.g., a numeral such as a “1” or a “0” from the date on the sample coin 312) may be used as a registration mark. Additionally, a point on the sample coin may be used in conjunction with the registration mark etched onto the sample platform 311.

Referring again to FIG. 3, an optical train of the optical sub-system includes a light source 314, a focusing lens 315, and an imaging slit 316. The light source 314, focusing lens 315, and imaging slit 316 are contained in an optical housing 317.

In one embodiment, the light source 314 may be a monochromatic light source such as continuous wave (CW) laser or a light emitting diode. In another embodiment, the light source may be a broadband light source with a monochromator thus allowing a series of data to be collected at a plurality of wavelengths. In still another embodiment, the light source may contain two or more monochromatic sources. Such a setup may have two CW lasers. The lasers may be chosen to more differentiate scattering from surface or near-surface features on the sample coin 312. For example, a helium-neon laser operating at 632.8 nm and an argon-ion laser operating at 488.0 nm allow characterization of a coin at differing skin depths. Also, multiple wavelengths may be useful for characterization of ancient coins which may have an oxide or other dielectric layer. The multiple wavelengths, combined with angle-of-incidence and polarization state differences, provide scattering signatures from the top of the dielectric as well as the top of the underlying coin surface. Possibilities from any of these combinations are known to a skilled artisan.

Further, the light source 314 may include a polarizer (not shown) to adjust an output polarization state of the source. The polarizer may be used in conjunction with the analyzer optionally placed in front of the output PiN diode array 313 described above.

The focusing lens 315 and the imaging slit 316 may be arranged in a variety of ways. For example, the light source 314 may be collimated through the use of an appropriate focusing lens 315 (i.e., in the form of a collimator) and the imaging slit 316 may be a field stop to limit the field of view of the optical system and thus prevent excessive internal reflections and scattering of the light source 314. Alternatively, the light source 314 may be focused onto the sample coin 312 by the focusing lens 315. In another embodiment, the focusing lens 315 may be arranged as a lens imaging system comprised of, for example, a spherical or bi-convex lens element in series with a negative cylindrical lens. As known to a skilled artisan, such a lens imaging system provides a “line” of light that may be tuned to be diffraction limited in one axis and long enough to cover any sample coin in an orthogonal axis. Any light fall off from a midpoint of the projected line can be readily compensated for in software coupled to the collection optics, discussed below. The imaging slit 316 may be used as a horizontally-oriented slit field stop to reduce stray light from falling on the sample coin 312.

The optical housing 317 (or alternatively, simply various components contained therein) may be arranged to mechanically vary angles-of-incidence between the light source 314 and the sample coin 312. As noted herein, various angles-of-incidence may have beneficial effects when deriving various scattering signatures from, for example, different materials. The optical housing may be arranged to scatter either from the face only of the sample coin 312 or from both the face and the edge. Further, the optical housing 317 may be alternately arranged (not shown) to scatter light only from the edge of the sample coin 312. Additionally, a separate optical housing (not shown) directed toward the edge of the sample coin 312 may be used in conjunction with the optical housing 317 set-up, in this exemplary arrangement, for scattering from the face of the sample coin 312.

Referring once again to FIG. 3, the optical sub-system of the exemplary scattering apparatus 300 further includes an input mirror prism 318 and an output prism 319. The input mirror prism 318 directs the beam output from the optical train of the optical sub-system.

In an alternative embodiment (not shown), the input mirror prism 318 may be replaced by a rotating polygonal mirror. The polygonal mirror is placed in line with the output beam and rotates at a selected speed thus sweeping the input beam across the face of the sample coin 312.

In an alternative embodiment (not shown), the input mirror prism 318 may be replaced by a vibrating front-surface mirror. The front-surface mirror is placed in line with the output beam and vibrates at a selected speed thus sweeping the input beam across the face of the sample coin 312.

In another alternative embodiment (not shown), the input mirror prism 318 may be replaced by a telecentric imaging system. The telecentric imaging system provides a beam of light having substantially constant power scanned over the face of the sample coin 312.

The output prism 319 directs scattered light to a tracking PiN diode array 320. The output prism 319 and tracking PiN diode array 320 allow tracking any eccentricities within the coin such as non-circularity or other geometric irregularities. Additionally, the output prism 319 and tracking PiN diode array 320 can be used to self-calibrate for repeatability and uniformity in specimen illumination.

A tracking screw 321 controlled by a tracking stepper motor 322 (or encoded servo motor or other control means known in the art) controls movement of the beam directing and collection optics over the sample coin 312. The optical housing 317 may also be controlled by the tracking screw 321 or may be fixed. Also, the output PiN diode array 313 may be controlled by the tracking screw 321 or may be fixed in a given location.

The tracking screw 321 may be coordinated with the mechanical coin drive sub-system in various ways. In one embodiment, the tracking screw 321 may scan the sample coin 312 in an Archimedes spiral. The Archimedes spiral will scan a face of the sample coin 312 either from the center to the edge of the sample coin 312 or from the edge into the center. The spiral temporally comprises a locus of points corresponding to the locations of a point moving away from a fixed point (e.g., either the center or a starting point on the edge) with a constant speed along a line which rotates with constant angular velocity. A particular point on the coin may be correlated back to, for example, either polar coordinate locations (i.e., r-θ) or Cartesian coordinates (i.e., x-y). In another exemplary embodiment, a logarithmic spiral may be utilized in which successive turns of the spiral are increased in a geometric progression. In still other embodiments, the sample coin 312 may be held stationary while the input mirror prism 318 is moved in both x- and y-coordinate positions thus providing a raster-scan of the sample coin 312 in which the beam is scanned over the surface of the sample coin 312, stepped translationally, and then scanned again until the entire surface is covered.

Although not shown, a skilled artisan will recognize that the optical sub-assembly may have a fixed location and a translational stage added to control movement of the sample platform 311 and, hence, movement of the sample coin 312.

Alternative scanners, optical components, scanning modalities and related technologies can be found in pending U.S. patent application Ser. No. 12/426,861 entitled “Apparatus for Producing Optical Signatures from Coinage” filed Apr. 20, 2009; Ser. No. 61/046,344 entitled “A calibrated and Color-Controlled Multi-Source Lighting System for Specimen Illumination” filed Apr. 20, 2009; Ser. No. 12/426,883 entitled Method for Poetically Collecting Numismatic Data and Associated Algorithms for Unique Identification of Coins” filed Apr. 20, 2009; Ser. No. 12/426,870 entitled “A Self-Centering Loading, Indexing and Flipping Mechanism for Coinage and Coin Analysis” filed Apr. 20, 2009; and Ser. No. 12/663,839 entitled “Coin-Edge Imaging Device” filed May 11, 2009. All of these pending applications are hereby incorporated by reference for all purposes as if included herein.

The present invention is described above with reference to specific embodiments thereof. It will, however, be evident to a skilled artisan that various modifications and changes can be made thereto without departing from the broader spirit and scope of the present invention as set forth in the appended claims. For example, particular embodiments describe an imaging system in the form of a digital still or video camera. A skilled artisan will recognize that other imaging systems may be employed. In other exemplary embodiments, particular applications of the coin imaging apparatus 100 or the scattering apparatus 300 may not need to record the entire visible spectrum. In certain applications, recording infra-red (IR) or ultraviolet (UV) images may be more useful to uniquely identify a coin. Further, angle-resolved light scattering or ellipsometric means may be employed to record a scattering signature with reference to an angular position of the coin. Also, a radio-frequency identification (RFID) integrated circuit may be embedded in the exemplary coin slab to further deter counterfeiting. These and various other embodiments are all within a scope of the present invention. The specification and drawings are, accordingly, to be regarded in an illustrative rather than a restrictive sense.

What is claimed is:

1. An coin storage device comprising:
an encapsulation portion configured to secure a coin therein and allow for visual inspection of the coin; and
a viewing port arranged on an edge of the encapsulation portion, the viewing port being configured to both allow a light source to impinge upon an edge of the coin and return a light signal from the edge of the coin.

2. The device of claim 1 wherein the viewing port includes an imaging rod.

3. The device of claim 1 further comprising an RFID device.

4. A coin storage device, comprising:
a slab of hard transparent material with a space for mounting a coin therein and with a transparent cover for the coin, the coin thereby being encapsulated by the slab; and
means associated with the slab for coupling light from a light source into the slab to an edge of the coin and to receive light back from the edge of the coin.

5. The coin storage device as in claim 4, wherein the slab is composed of a polymer selected to have minimal outgassing and amenable to ultrasonic welding or adhesive bonding of the cover.

6. The coin storage device as in claim 5, wherein the polymer is polymethylmethacrylate.

7. The coin storage device as in claim 5, wherein the polymer is poly(methyl 2-methylpropenoate).

8. The coin storage device as in claim 5, wherein the polymer is a polycarbonate.

9. The coin storage device as in claim 4, wherein the slab is composed of a glass.

10. The coin storage device as in claim 9, wherein the glass is a soda-lime glass.

11. The coin storage device as in claim 9, wherein the glass is a borosilicate glass.

12. The coin storage device as in claim 4, wherein the means for coupling light comprises a viewing port configured in an edge of the slab so as to allow light from a light source to impinge upon the edge of the coin.

13. The coin storage device as in claim 12, wherein the viewing port has a size on the order of one to two millimeters sufficient to allow unimpeded access of light to a width of the edge of the coin.

14. The coin storage device as in claim 12, wherein the viewing port comprises an optical imaging element selected from any of a graded-index (GRIN) lens element, imaging rod, or fiber-optic tube positioned in the slab such that at least a portion of the edge of the coin can be imaged without removing the coin from the slab.

15. A method of viewing an edge of a coin encapsulated within a coin storage device, the method comprising:
directing light from a light source through a viewing port of the coin storage device, the light impinging upon and illuminating at least a portion of the edge of the coin encapsulated within the coin storage device; and
receiving light back through the viewing port from the illuminated portion of the coin edge, the received light being detected so as to determine an identity of the encapsulated coin without removal of the coin from coin storage device.
